(19) United States
(12) Patent Application Publication
(10) Pub. No.: US 2006/0032857 A1
(43) Pub. Date: Feb. 16, 2006

(54) Packaging, and a mould and a method for making the packaging

(76) Inventors: Michael Stensbol, Vaerlose (DK); Lars Pudselykke, Holbaek (DK); Anne-Lise Hog Lejre, Taastrup (DK); Soren Pedesen, Taastrup (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/981,754

(22) Filed: Nov. 5, 2004

(30) Foreign Application Priority Data
Aug. 10, 2004 (EP) 04 388 054.1

(51) Int. Cl. B65D 41/18; B28B 1/14

(52) U.S. Cl. 220/780; 264/299; 220/792

(57) ABSTRACT

A packaging (1) including an injection moulded plastic container (40) and a plastic lid (10), said container (40) having a bottom (42) and a peripheral side wall (46) extending from said bottom and defining opposite said bottom a peripheral rim, (47), said side wall having connecting means (26) for attaching said plastic lid (10) to said container in a tight relationship, said lid and said side wall tightly abutting each other in a peripheral sealing area (A) adjacent said rim (47) when said lid is attached to said container, characterised in the lid and the side wall having on the surfaces thereof facing the inside of the packaging (1) a number of projections (8), said projections (8) on said side wall defining a number of side wall recesses (9) and being integrally formed in the injection moulding process by the plastic material forming the container side wall (46) flowing into mould recesses formed in said injection mould.

The present invention relates to a packaging for liquid paint or the like, produced from a polymeric resinous material and having surfaces for enhanced adhesion of a film of said liquid paint or the like deposited thereon. Specifically, the invention concerns a packaging including a plastic container and a plastic lid, the container having a bottom and a peripheral side wall extending from said bottom and defining opposite said bottom a peripheral rim, the side wall having connecting means for attaching the plastic lid to the container in a tight relationship, the lid and the side wall tightly abutting each other in a peripheral sealing area adjacent the rim when the lid is placed on the container. By paint and the like is meant liquid surface coatings, i.a. paints, enamels, varnishes and lacquers. The paint may be based on water or a solvent.

Injection moulded liquid paint containers and lids manufactured from polymeric resinous materials such as polyethylene or polypropylene exhibit the problem of having a low to almost negligible surface adhesion for dried paint. On certain surface areas, such as the underside of the lid and the inside container surface exposed above the liquid paint level, this low adhesion can be particularly deleterious. Liquid paint splashes and coats these surfaces during shipment of the packaging with the paint, during mixing of the paint, such as when the packaging holding paint is placed in a vibrator in the paint store, and during the actual painting process where the painter may temporarily leave his brush resting on the underside of the lid.

Often, before the paint is initially used, or reused after partial application, this surface coating dries. Later removal of the lid, or subsequent simple mixing of the liquid paint, for example by stirring with a wooden paddle, can lead to chipping, flaking and peeling of the dry paint, and lead to deposition of flakes conventional mixing techniques and thus brush out on application of the paint as unattractive specks and lumps.

Various proposals have been advanced in an attempt to solve the aforementioned problem. WO 02/94 582 and WO 01/32 442 both suggest providing a paint container with a coating or otherwise treating the inside surface of the finished container such that the adhesion for the dried paint is increased. WO 00/27 725 suggests forming the inside of a paint container and the underside of the lid with a lining of a material capable of retaining a layer of paint thereon whereby flakes of the paint do not fall into the body of the paint.

The above prior art containers and lids involve the problem that the processes leading to their manufacture are complicated giving rise to high manufacturing costs, making the proposed solutions less attractive from a commercial point of view. Hence, there is a need for a packaging that not only provides for a high adhesion for dried paint but which can also be made in a simple and cost-effective way.

The aforementioned problems are solved by the packaging defined in claim 1. In use, any paint deposited on the container side wall sticks to the side wall through the increased surface area defined by the surface of the side wall projections formed in the injection moulding process, and will remain firmly anchored thereto when dry. A mould for forming a container having these properties is defined in claim 14.

Surprisingly, it is possible to remove from an injection mould male part after the moulding a plastic paint container having projections on the inside surface of the side wall sufficient for retaining a layer of dry paint thereon, thus permitting the packaging to be manufactured in the desired cost-efficient way while still ensuring a high degree of adhesion to dried paint on the inside surface of the container. Preferably, the lid is also manufactured by injection moulding.

Preferably, at least an area, and preferably the entire area, of the aforementioned surfaces facing the inside of the packaging have a 3D roughness Rₐ greater than about 15 μm, preferably greater than 20 μm, more preferably greater than 40 μm and most preferably greater than 53 μm. Preferably, the 3D roughness Rₐ of the inside of the container side wall is at minimum 40 μm and at most 70 μm. The 3D roughness Rₐ is determined in accordance with DIN 4768, ISO/DIS 4287/1, DIN 4762/1 and DIN 4774. The side wall recesses, i.e. those areas between the projections, preferably have a depth R of 0,1 mm-0,35 mm.

The embodiment of claim 8 allows for an adhesion on the lid of paint that splashes up into the narrow annular space between the lid and the side wall during mixing of the paint, such as in a vibrator at a paint store. Although a surface with the roughness defined in claim 8 may provide for an adhesion slightly inferior to the adhesion provided by the underside of the lid, this embodiment still provides for an adherence in an area of the lid where establishing a greater roughness in the injection moulding process would be complicated.

The embodiment of claim 10 allows for a highly reliable retention of most paints on the exposed surface of container while still permitting removal of the container from the injection mould.

The invention will now be discussed in further details with reference to preferred embodiments shown in the drawing.

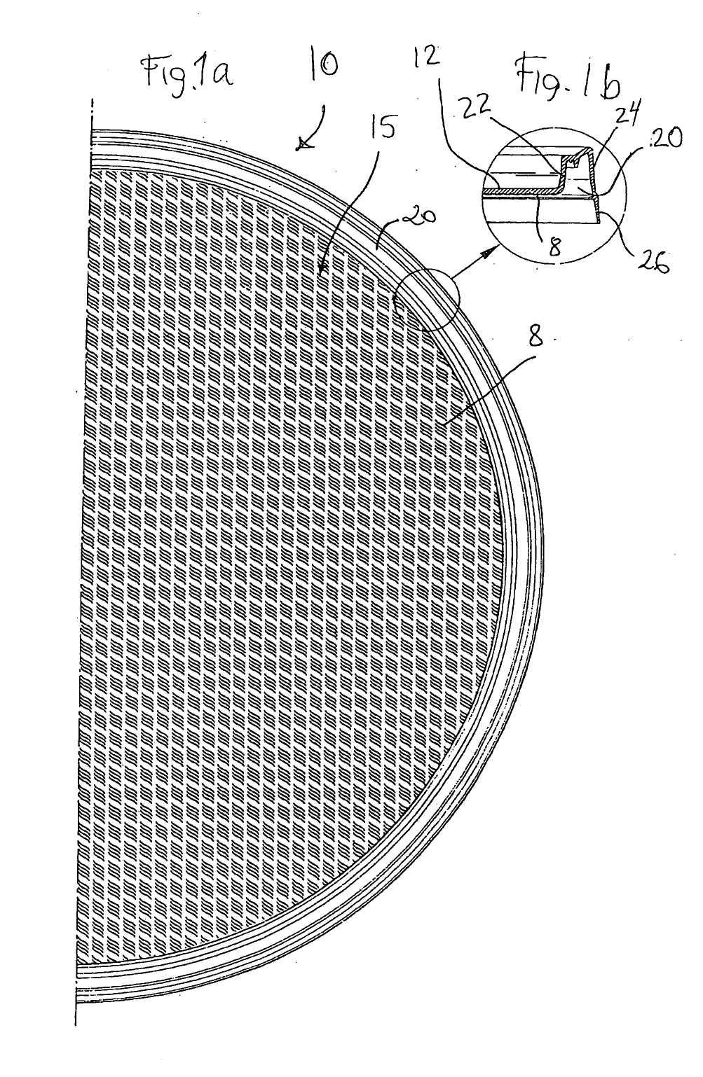

FIG. 1a shows a plastic lid for a plastic container, seen from below, and provided with a pattern of projections according to one embodiment of the invention

FIG. 1b is a sectional view of the encircled part of the lid shown in FIG. 1a,

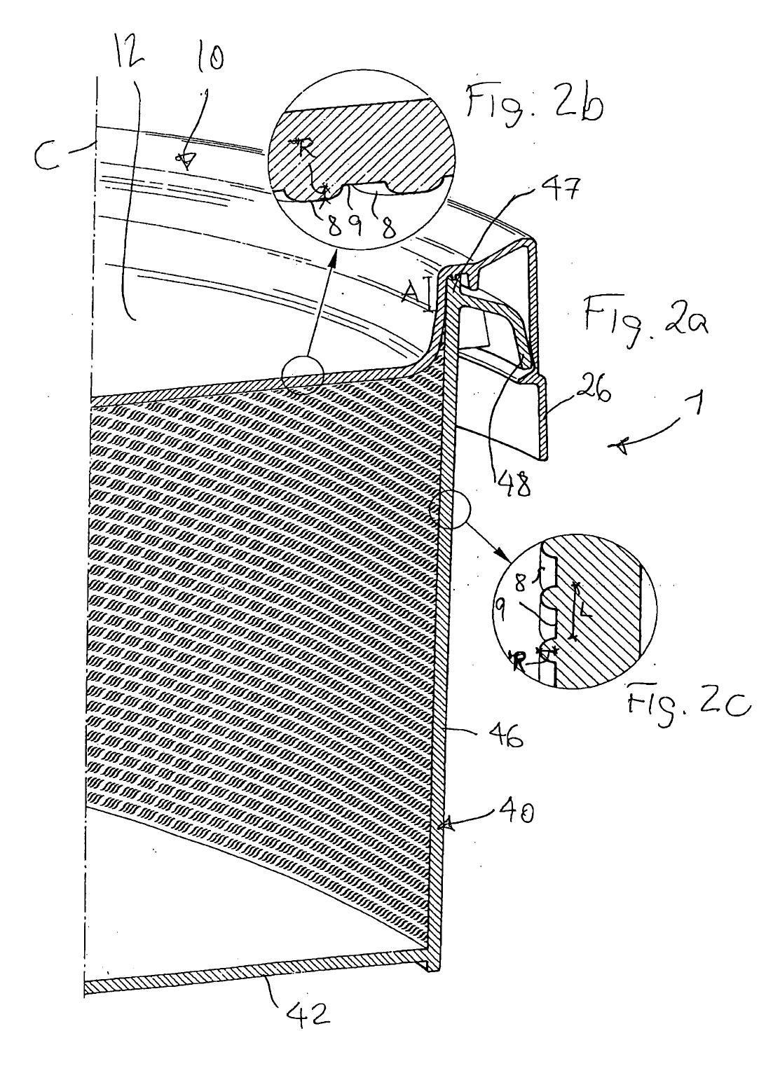

FIG. 2a is a cross-sectional view of a container with a lid applied thereon,

FIG. 2b is an enlarged sectional view of the encircled part of the lid shown in FIG. 2a,

FIG. 2c is an enlarged sectional view of the encircled part of the container side wall shown in FIG. 2a,

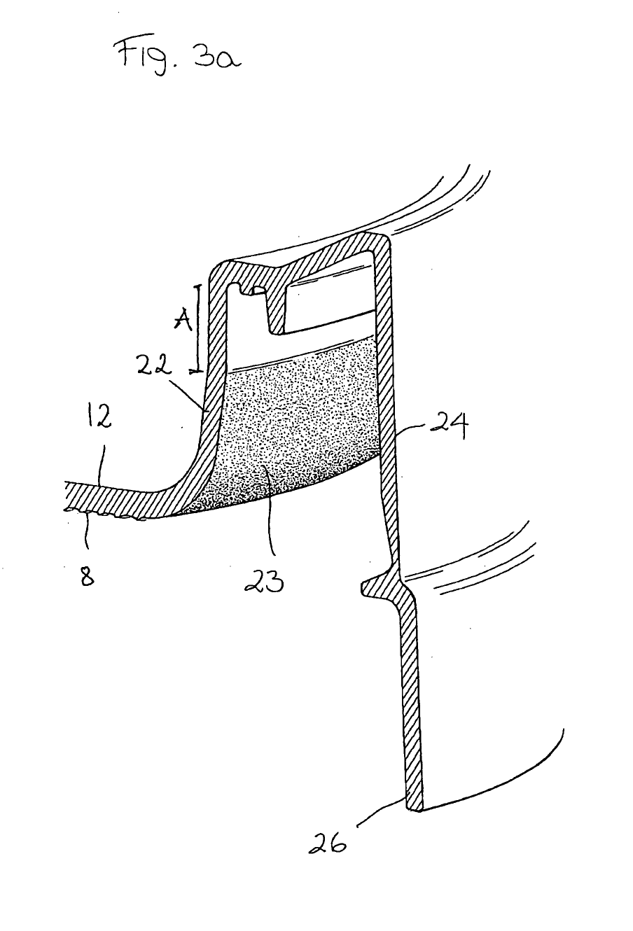

FIG. 3a is a perspective sectional view of the lid of FIG. 1a,

FIG. 3b is a side view of the packaging in the sealing area,

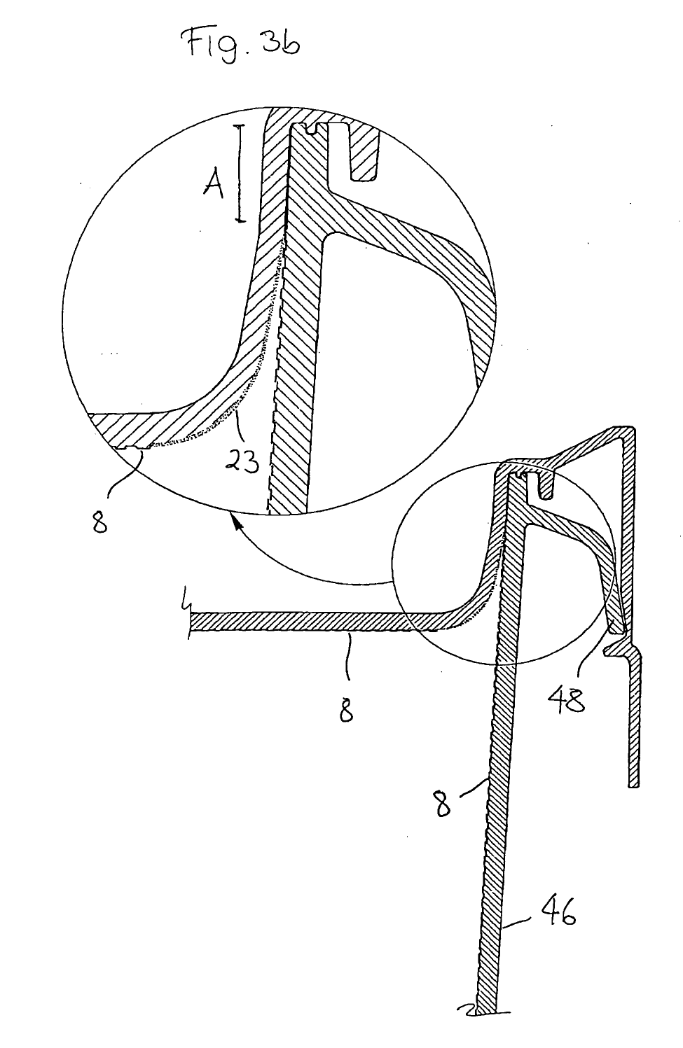

FIG. 4a shows a front view of a part of the inside surface of the container side wall provided with a pattern of projections in accordance with a second embodiment of the invention.

FIG. 4b shows a sectional view of the projections according to the second embodiment,

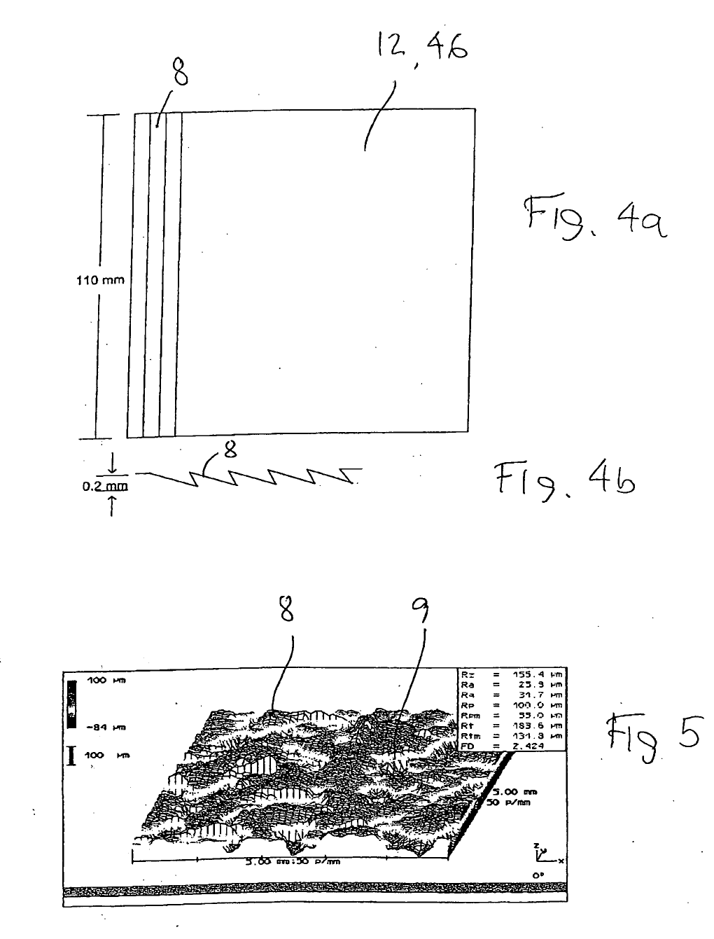

FIG. 5 is a 3D view of a part of the inside surface of a container side wall according to a third embodiment of the invention, having surface projections formed through the use of a mould male part with a peripheral surface that has been subjected to photo etching, and

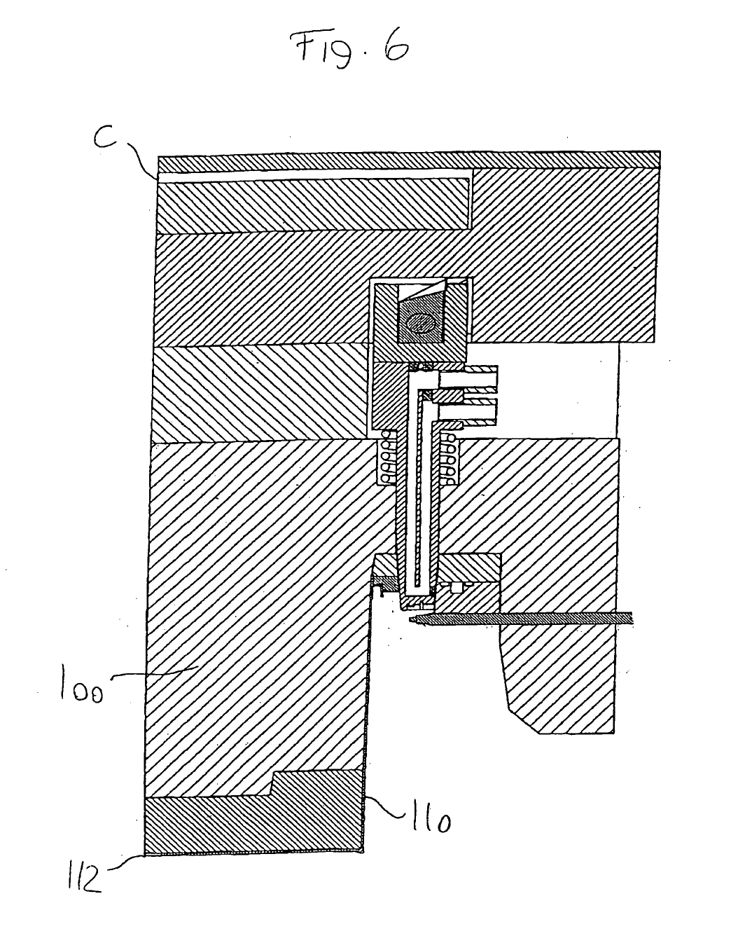

FIG. 6 shows an exemplary male part for an injection mould for use in making the container part of the packaging.

FIG. 1 shows a plastic lid 10 for a container for a packaging according to the invention. The underside of the lid 10 that faces the interior of the packaging when the lid 10 is applied on the container is provided with a plurality of groups 15 of identical projections 8. Each group 15 comprises four such projections, and each projection 8 has in this example an S-like configuration. The projections 8 define between each other indentations or recesses, with the indentations being wider in areas between the groups 15 of projections than between the individual projections 8 of each group 15.

The lid 10 has a peripheral groove 20 defined by a smaller radius wall 22 and a larger radius wall 24, and extending around a central part 12 of the lid 10. The larger radius wall 24 has connecting means 26 cooperating with connecting means on the container to allow for the lid 10 to be attached to the container in a tight relationship, and a peripheral area of the surface of the smaller radius wall 22 facing the larger radius wall 24 defines together with the rim of the container a peripheral sealing area, as shown in FIG. 2a.

FIG. 2a shows the packaging 1 with the lid 10 applied on a container 40 having a bottom 42, a side wall 46 ex tending from the bottom 42 and having a peripheral rim 47. The container 40 is slightly conical with the wall 46 typically defining a small angle in the order of 0,2°-5°, preferably 1°-3°, with respect to the central axis C of the container 40, and may be provided with a handle. Paint containers are typically manufactured from polyethylene, preferably polypropylene, such that the container will substantially maintain its shape in use.

Connecting means in the form of a peripheral flange 48 on the outside surface of wall 46 at the rim 47 cooperate with the aforementioned connecting means 26 of the lid to keep the lid 10 attached to the container 40 in a tight relationship through the connecting means 26 engaging the flange 48 by snap-action. In this position, a peripheral area of the inside surface of the wall 46 seals against the aforementioned peripheral area of the surface of the smaller radius wall 22, thus providing a peripheral sealing area A.

FIGS. 2b and 2c show an enlarged sectional view of the lid 10 and the side wall 46, respectively, with the projections 8 and the intermediate indentations or recesses 9 being visible. The S-like projections 8 may eg. have a length L in the order of 2-4 mm, and a height R in the order of eg. 0,1 mm-0,25 mm. As shown, on the side wall 46 the projections 8 are formed in an area extending from but not including the peripheral area A to the bottom 42. Such a pattern of projections 8 would provide the side wall 46 with a 3D roughness Rₐ in the order of 58 μm.

FIG. 3a shows the groove 20 for receiving the peripheral rim 47. An area 23 of the smaller radius wall 22 extends below the peripheral sealing area A, i.e. in the narrow annular gap between the lid and the side wall. It may be difficult to establish in this area 23 the same roughness as on the underside of the lid 10 although some degree of roughness is certainly desired in this area due to paint being deposited here in the course of mixing the paint in a vibrator. Hence, the mould forming the lid 10 may be adapted to establish in this area 23 a different pattern of projections with a 3D roughness Rₐ of at minimum 10 μm and at most 20 μm, and with a similar maximum height.

FIG. 3b shows the sealing area A of the packaging 1, with the projections 8 on side wall 46 preferably extending up, but not into, to the peripheral area of the side wall 46 abutting the outer surface of the smaller radius wall 22 of the lid 10 in the sealing area A.

FIG. 4a shows an alternative pattern of projections 8 that may be formed on the inside of side wall 46, and also on the underside of the lid 10 although the lid may be provided with any other configuration of the projections. The projections 8 extend in the general direction of the central axis C of the container, and may be in cross-section as shown in FIG. 4b, i.e. with a barb-like structure providing a strong adherence or anchoring of the dried paint to the side wall 46.

FIG. 5 shows yet another, more irregular pattern of projections 8 that may alternatively be formed on the side wall 46 in the injection moulding process, and that may also provide the surface with the same roughness Rₐ mentioned above.

FIG. 6 shows one half (the central line C being the leftmost line) of a solid, non-collapsible conical male part 100 for a mould for injection moulding, the male part 100 defining together with a female part (not shown) a cavity for making a container according to the invention. The male part 100 has a first conical surface 110 defining the inside surface of the peripheral side wall 46 of the container 40, and the male part 100 is provided with a pattern of indentations, preferably evenly distributed across the entire first surface.

Preferably, the indentations are such as to provide the male part 100 with a 3D roughness Rₐ greater than about 15 μm, preferably greater than 20 μm, more preferably greater than 40 μm and most preferably greater than 53 μm, preferably no more than 70 μm, for providing the required degree of roughness of the inside of the peripheral side wall 46 of the container in the injection moulding. The male part 100 may have the aforementioned indentations only up to a peripheral region forming the rim 47 of the container. The first surface 110 may have recesses with a depth R of 0,1 mm-0,35 mm, all recesses all having the same depth, or essentially the same depth. The male part 100 may as shown be provided with a template 112 forming the first surface 110 and having the indentations, and the indentations or roughness may be provided by a sandblasting or etching the male part 100 surface, or the surface of the template. The pattern of indentations formed in the template 112 or the male part may be as shown schematically in FIG. 5 for rendering a similar structure on the inside of side wall 46, or the male part 100 may carry any pattern resulting in the desired image on the wall 46, such as the image shown in FIGS. 2a and 4b.

After completion of the injection of the plastics material in the cavity between the male and female parts of the mould, the finished container with indentations on the inside of the side wall 46 may be pulled off the male part 100, even though projections 8 are formed on substantially the entire inner surface of the wall 46 abutting the first surface 110 of the male part 100.

1. A packaging (1) including an injection moulded plastic container (40) and a plastic lid (10), said container (40) having a bottom (42) and a peripheral side wall (46) extending from said bottom and defining opposite said bottom a peripheral rim (47), said side wall having connecting means (26) for attaching said plastic lid (10) to said container in a tight relationship, said lid and said side wall tightly abutting each other in a peripheral sealing area (A) adjacent said rim (47) when said lid is attached to said container, characterised in the lid and the side wall having on the surfaces thereof facing the inside of the packaging (1) a number of projections (8), said projections (8) on said side wall defining a number of side wall recesses (9) and being integrally formed in the injection moulding process by the plastic material forming the container side wall (46) flowing into mould recesses formed in said injection mould.

2. A packaging according to claim 1, at least an area, and preferably the entire area, of said surfaces facing the inside of the packaging having a 3D roughness Rₐ greater than about 15 μm, preferably greater than 20 μm, more preferably greater than 40 μm and most preferably greater than 53 μm.

3. A packaging according to claim 1 or 2, at least an area, and preferably the entire area, of said surfaces facing the inside of the packaging having a 3D roughness Rₐ of at minimum 40 μm and at most 70 μm.

4. A packaging according to any of the preceding claims, characterised in said lid (10) being injection moulded.

5. A packaging according to any of the preceding claims, said projections (8) being substantially identical, or identical, in shape and being uniformly distributed on said surfaces.

6. A packaging according to any of the preceding claims, said peripheral sealing area (A) being inside said side wall (46).

7. A packaging according to the preceding claim, said projections (8) on said side wall (46) being formed solely in the area extending from said peripheral sealing area (A) towards said bottom (42).

8. A packaging according to claim 6 or 7, said lid (10) including a peripheral groove (20) for receiving said peripheral rim (47), said groove (20) being defined by a smaller radius wall (22) and a larger radius wall (24), said smaller radius wall (22) defining at least in part together with said side wall (46) said peripheral sealing area (A), said smaller radius wall (22) having outside said peripheral sealing area (A) a rough surface having a 3D roughness Rₐ of at minimum 10 μm and at most 20 μm.

9. A packaging according to any of the preceding claims, said container having a central axis (C) extending essentially perpendicular to said bottom (42), said peripheral side wall (46) being conical and sloping at an angle with respect to said central axis (C) of 0,2°-5°, preferably 1°-3°, with the container (40) having the smaller radius at said bottom (42).

10. A packaging according to any of the preceding claims, said projections (8) on said side wall (46) being generally orientated in the direction of said central axis (C).

11. A packaging according to any of the preceding claims, said side wall (46) recesses (9) having a depth (R) of 0,1 mm-0,70 mm, preferably 0,1 mm 0,35 mm.

12. A packaging according to the preceding claim, said recesses (9) all having essentially the same depth (r), or the same depth.

13. A packaging according to any of the preceding claims, said projections (8) having a barb-like configuration.

14. A mould for the injection moulding of a paint container (40) having a bottom and a peripheral side wall (46) extending from said bottom and defining opposite said bottom a peripheral rim, said side wall having peripheral connecting means for attaching a plastic lid to the container, said mould including a female part and a cylindrical or conical male part (100) for defining an injection mould cavity, characterised in said male part (100) having a peripheral first surface defining the inside surface of said peripheral side wall, said first surface (110) having a plurality of indentations (9) along the periphery for forming projections (8) on said peripheral side wall (46) during said injection moulding.

15. A mould according to claim 14, said first surface (110) having a 3D roughness Rₐ greater than about 15 μm, preferably greater than 20 μm, more preferably greater than 40 μm and most preferably greater than 53 μm, for defining said projections (8).

16. A mould according to claim 14 or 15, at least an area, and preferably the entire area, of said first surface (110) having said indentations (9).

17. A mould according to any of claims 14-16, said first surface (110) having a 3D roughness Rₐ of at minimum 40 μm and at most 70 μm.

18. A mould according to any of claims 14-17, said first surface (110) having the roughness Rₐ only in an area distant from a peripheral region (A) forming

19. A mould according to any of the preceding claims 14-18, said indentations (9) having a depth R of 0,1 mm-0,70 mm, preferably 0,1 mm-0,35 mm.

20. A mould according to the preceding claim, said indentations (9) all having the same depth, or essentially the same depth.

21. A mould according to any of the preceding claims 14-20, said male part (100) having a template (112) forming said first surface (110).

22. A mould according to any of the preceding claims 14-21, said indentations (9) being provided by sandblasting or etching said male part (100).

23. A mould according to any of claims 14-22, said male part having a central axis (C), said first surface (110) being conical and sloping at an angle with respect to said central axis (C) of 1°-3°.

24. A method of making a container having a bottom and a peripheral side wall extending from said bottom and defining opposite said bottom a peripheral rim, said side wall having connecting means for attaching said plastic lid to said container in a tight relationship, said lid and said side wall tightly abutting each other in a peripheral sealing area adjacent said rim when said lid is attached to said container, characterised in the lid and the side wall (46) having on the surfaces thereof facing the inside of the packaging a number of projections, said projections (8) on said side wall defining a number of side wall recesses (9) and being integrally formed in the injection moulding process by the plastic material forming the container side wall flowing into mould recesses (9) formed in said injection mould.
